(19) United States
(12) Patent Application Publication
(10) Pub. No.: US 2024/0391784 A1
(43) Pub. Date: Nov. 28, 2024

(54) METHOD OF NITROGEN FIXATION IN A PLASMA REACTOR

(71) Applicant: plasNifix AG, Zurich (CH)

(72) Inventors: Johannes GRÜNWALD, Taxenbach (AT); Martin POMS, Zurich (CH)

(73) Assignee: plasNifix AG, Zurich (CH)

(21) Appl. No.: 18/685,421

(22) PCT Filed: Jul. 25, 2022
(86) PCT No.: PCT/EP2022/070839

§ 371 Date: Feb. 21, 2024

(30) Foreign Application Priority Data
Aug. 23, 2021 (AT) A 144/2021

(51) Int. Cl. C01C 1/04

(52) U.S. Cl. CPC C01C 1/0494; C01C 1/0405

(57) ABSTRACT

A method of nitrogen fixation uses a synthesis gas formed of several gaseous reactants for the synthesis of a synthesis product; and a process gas formed by admixing a gaseous catalyst with the synthesis gas, with the molar proportion of the catalyst in the process gas no more than 33%. The mixing ratio for the several gaseous reactants in molar proportions is determined by: determining all atom types in the synthesis product; calculating the reciprocal of the total effective cross section (RTECS) for the ionization and excitation of atoms by electron impacts on the respective atom type; multiplying the RTECS values by the number of atoms of the respective atom type in the synthesis product; determining the mixing ratio of the reactants, in that the number of atoms of the atom types in the reactants corresponds approximately to the ratio of the multiplied RTECS values for the corresponding atom types.

### TECHNICAL FIELD

The invention relates to a method for nitrogen fixation, in particular ammonia synthesis, in a plasma reactor.

### TECHNICAL BACKGROUND

Worldwide, the so-called Haber-Bosch process is still the most commonly used method for synthesising ammonia. The central step of the process, the synthesis of ammonia from atmospheric nitrogen and hydrogen, is carried out on a solid-state catalyst at pressures of around 150 to 350 bar and temperatures of around 400 to 500° C. This process emits around 420 million tonnes of CO₂ per year worldwide. In addition, there are other emissions that occur in other processes for nitrogen fixation (for example in the production of nitric acid, etc.). A large proportion of these emissions are caused by heating the process gases hydrogen and nitrogen to over 450° C. and compressing them to up to 20 MPa (Shi, Run, et al. “The Journey toward Low Temperature, Low Pressure Catalytic Nitrogen Fixation.” Advanced Energy Materials 10.19 (2020): 2000659). The high temperatures and pressures are designed for the use of solid-state catalysts (for example Ru-, Mo- or Fe-based catalysts). These catalysts are necessary in order to achieve significant yields of the relevant nitrogen compounds. From a thermodynamic point of view, however, high pressures at low temperatures are desirable for the optimum reaction pathways.

Solid-state catalysts have another serious disadvantage: they only allow a two-dimensional arrangement within a reactor, i.e. the necessary chemical reactions can only take place at the catalyst surface, which significantly reduces the number of available reaction sites.

According to the current prior art, the partial problem of high temperatures can be solved by electrochemical, plasma-supported synthesis processes, as at least no high temperatures are required here.

This is usually realised with the above-mentioned solid-state catalysts in order to achieve significant yields.

The production of ammonia by low-temperature plasma is described, for example, in U.S. Pat. No. 4,877,589, CN111362278 or WO2011104386. Solid-state catalysts are used in order to obtain an appreciable yield of ammonia.

The further prior art on the topics of ammonia synthesis and nitrogen fixation is also distinguished in that a significant yield from a mixture of hydrogen and nitrogen can only be achieved by using solid-state catalysts.

JP2017164736 A describes a plasma reactor and a process for synthesising ammonia at temperatures of 25 to 500° C. and pressures of 101 to 1000 kPa in the presence of a catalyst. In particular, aluminium, titanium, iron, palladium, nickel, copper, zinc, silver, platinum and gold are mentioned as catalysts. JP2017164736 A investigated the effectiveness of the Penning effect in ammonia synthesis by adding helium, argon or hydrogen to the raw gas (hydrogen and nitrogen). The ammonia yield could be increased with increasing amounts of the noble gases in the reaction mixture, with a value of 75% helium in the reaction mixture being explicitly mentioned. At 50% or less, no significant increase in yield was observed.

WO2020115473 A1 describes a plasma reactor and a process for nitrogen fixation for the production of nitrogen oxides, in particular NO and NO₂. The process is carried out in the presence of a catalyst and at pressures ranging from atmospheric pressure to 4 bar. The temperature is only stated to be reduced to below 1000 K after the reactor. The catalysts mentioned are iron, nickel, zeolites, transition metal oxides, platinum and rhenium. Noble gases (Ar, Ne, He) and carbon dioxide are added to reduce the ionisation potential of the plasma. No quantities are specified. And no connection between the noble gases and the yield of nitrogen oxides is recognised.

Hessel, V. et al. “Energy, catalyst and reactor considerations for (near)-industrial plasma processing and learning for nitrogen-fixation reactions” Catalysis today 2013, 211, 9-28, <doi:10.1016/j.cattod.2013.04.005> provides an overview of the current state of research and industrial applications of plasma-assisted reactions. It also deals with nitrogen fixation and in particular ammonia production, in which solid-state catalysts are used throughout.

Hessel, V. et al. (“Industrial applications of plasma, microwave and ultrasound techniques: Nitrogen-fixation and hydrogenation reactions” Chemical Engineering and Processing: Process Intensification 2013, 71, 19-30, <doi:10.1016/j.cep.2013.02.002>) investigates the industrial applicability of plasma-assisted nitrogen fixation in relation to the production of nitrogen monoxide, using catalysts and occasionally noble gas-containing plasma.

EP3162435 A1 describes the production of ammonia at normal temperature in a plasma reactor using a phase interface reaction at the phase boundary between nitrogen and water. The use of a catalyst and the addition of noble gases are not described.

WO2019183646 A1 describes the electrochemical production of ammonia from nitrogen-containing plasma and water at 25° C. and normal pressure and without a catalyst. In comparative tests, argon was used in the plasma and nitrogen was passed through, but this reduced the ammonia yield.

Nakajima, J. et. al. (“Synthesis of ammonia using microwave discharge at atmospheric pressure”, Thin Solid Films, Volume 516, Issue 13, 2008, p. 4446-51, doi.org/10.1016/j.tsf.2007.10.053) describes the synthesis of ammonia from nitrogen and hydrogen in atmospheric microwave plasma. By adding Ar to the plasma gas, these reactions can contribute to the formation of active nitrogen species, especially N and N⁺, and consequently the production rate of ammonia is expected to increase with the Ar flow rate. When the Ar flow rate is above 10 l/min, the production rate of ammonia starts to decrease as the absolute amount of N₂ in the plasma gas is lower.

### REFERENCES

Buckman, S. J., and B. Lohmann. “Low-energy total cross section measurements for electron scattering from helium and argon.” Journal of Physics B: Atomic and Molecular Physics 19.16 (1986): 2547.
Itikawa, Yukikazu. “Cross sections for electron collisions with nitrogen molecules.” Journal of physical and chemical reference data 35.1 (2006): 31-53.
Yoon, Jung-Sik, et al. “Cross sections for electron collisions with hydrogen molecules.” Journal of Physical and Chemical Reference Data 37.2 (2008): 913-931.
Itikawa, Yukikazu. “Cross sections for electron collisions with oxygen molecules.” Journal of Physical and Chemical Reference Data 38.1 (2009): 1-20.
Itikawa, Yukikazu. “Cross sections for electron collisions with carbon monoxide.” Journal of Physical and Chemical Reference Data 44.1 (2015): 013105.
Itikawa, Yukikazu. “Cross sections for electron collisions with carbon dioxide.” Journal of Physical and Chemical Reference Data 31.3 (2002): 749-767.
Stein, T. S., et al. “Measurements of total scattering cross sections for low-energy positrons and electrons colliding with helium and neon atoms.” Physical Review A 17.5 (1978): 1600.
Subramanian, K. P., and Vijay Kumar. “Total electron scattering cross sections for argon, krypton and xenon at low electron energies.” Journal of Physics B: Atomic and Molecular Physics 20.20 (1987): 5505.
Joshipura, K. N., and P. M. Patel. “Electron impact total (elastic+inelastic) cross-sections of C, N & O atoms and their simple molecules.” Journal of Physics D Atoms, Molecules and Clusters 29.4 (1994): 269-273.
Laher, R. R. & Gilmore, F. R., “Updated excitation and ionization cross sections for electron impact on atomic oxygen”, Journal of Physical and Chemical Reference Data, American Institute of Physics for the National Institute of Standards and . . . , 1990, 19, 277-305
Berrington, K. A.; Burke, P. G. & Robb, W. D., “The scattering of electrons by atomic nitrogen”, Journal of Physics B: Atomic and Molecular Physics, IOP Publishing, 1975, 8, 2500-2511
Vriens, L. & Smeets, A. H. M. “Cross-section and rate formulas for electron-impact ionization, excitation, deexcitation, and total depopulation of excited atoms”, Phys. Rev. A, American Physical Society, 1980, 22, 940-951

### DISCLOSURE OF THE INVENTION

One object of the invention is to provide a method of nitrogen fixation which is optimised with regard to a high yield alongside a low energy input.

This object is achieved by a method having the features of claim 1. The method of nitrogen fixation in a plasma reactor comprises the following steps: (a) providing a synthesis gas of one or several gaseous reactants for the synthesis of a synthesis product, wherein in the case of two or more gaseous reactants the mixing ratio in molar proportions of the reactants is determined as follows: (a.1) determining all atom types in the synthesis product; (a.2) calculating the reciprocal of the total effective cross section for the ionisation and excitation of atoms by electron impacts (determined at approximately 5 eV) of the respective atom type; (a.3) multiplying the reciprocal total effective cross section values of the atom types by the number of atoms of the atom types in the synthesis product (weighted reciprocal total effective cross section of the atom types); (a.4) determining the mixing ratio of the reactants, in that the number of atom types in the reactants corresponds approximately to the ratio of the multiplied or weighted reciprocal total effective cross section values for the corresponding atom types;
(b) providing a process gas by admixing a gaseous catalyst with the synthesis gas, wherein the molar proportion of the catalyst in the process gas is not more than 33%;
(c) introducing the process gas into a plasma reactor for the synthesis of the synthesis product from the reactants;
(d) separating off the synthesis product;
(e) recycling the excess or residual reactants and the gaseous catalyst, with admixture of new reactants, in order to obtain the process gas with the mixing ratios according to steps a) and b);
(f) repeating steps (c) to (f).

The increase in efficiency in the chemical reactions taking place is achieved by the fact that the gases mentioned are relatively easy to ionise and can therefore provide high electron densities with relatively low energy input, which then dissociate, ionise or chemically excite the molecules of the starting gases (O₂, N₂, H₂, etc.) (above all by exciting the rotational and vibrational degrees of freedom of the starting molecules) in order to increase the chemical potential and allow the reactions to take place faster and with lower energy input and lower temperatures.

A further advantage of the process described is based on the fact that the atoms/molecules of the gaseous catalyst are distributed evenly across the reactor volume and therefore offer a three-dimensional scaling of the reaction sites, which significantly increases efficiency.

The invention is further based on the realisation that the calculation of the mixing ratio by means of the total effective cross section of the individual atom types when using gaseous catalysts leads to better yields with lower energy input. This unique mixing ratio of the reactants in conjunction with the use of gaseous catalysts is explained by the fact that when such catalysts are used, the chemical processes are initiated by collisions of the process gas particles with the free electrons supplied by the catalyst gases. For this reason, the effective cross section for inelastic and elastic collisions between electrons and process gas particles is taken into account when determining the optimum gas mixture. However, these effective cross sections for nitrogen are about three times as large as for hydrogen.

The following values can be assumed for the total effective cross sections:

| Atom | Total effective cross section | |
|---|---|---|
| type | in 10\hat{ } − 20 m2 (at 5 eV) | Source |
| N₂ | 11.8 | Itikawa2006 |
| H₂ | 15.4 | Yoon2008 |
| O₂ | 7.55 | Itikawa2009 |
| CO | 14.5 | Itikawa2015 |
| CO₂ | 9.1 | Itikawa2002 |
| C | 15.01 (at 10 eV) | Joshipura1994 |
| He | 5.26 | Buckman1986 |
| Ne | 2.8 | Stein1978 |
| Ar | 8.81 | Buckman1986 |
| Xe | 35 | Subramanian1987 |
| O | 0.003 | Laher1990 |
| N | 14 | Berrington1975 |
| H | 5 | Vriens1980 |

For example, to produce the synthesis product ammonia (NH₃) from nitrogen (N₂) and hydrogen (H₂), the mixing ratios of the reactants (N₂ and H₂) of the synthesis gas can be calculated as follows. The atom types of NH₃ are N and H (step a. 1). The total effective cross-section (wq) [in 10\hat{ }-20 m²] for N and H is wqN=14 and wqH=5, respectively. The reciprocal value (1/wq) is 1/wqN=0.07 and 1/wqH=0.2, respectively. The sum of the reciprocal values (1/wq) for all atoms of the respective atom types (N and H) of the synthesis product are for 1×1/wqN=0.07 and for 3×1/wqH=0.6 (step a.3). This results in an optimum mixing ratio for N₂:H₂ of 1:8.4 or an approximate mixing ratio of 1:9 (step a. 4).

According to the present invention, the optimum mixing ratio of the reactants N₂ and H₂ for an optimum yield of the ammonia synthesis is N₂/H₂≈1/9. This is in contrast to the mixing ratio in the conventional Haber-Bosch process (N₂/H₂=1/3). The processes can therefore be run with gas mixtures with a lower nitrogen content compared to the conventional Haber-Bosch process, which also results in more efficient fixation.

At the end of a process cycle, the respective reactive nitrogen compound (i.e. the desired product of the reaction, e.g. NH₃) is discharged and non-reactive reactants and also the gaseous catalyst are returned to the reactor. The percentage ratio of the recycled gaseous reactants remains approximately constant here. The process is therefore also distinguished by the fact that the catalysts leave the reactor continuously and are then transferred back into the reactor chamber. Only new reactants are added in order to restore the initial ratio between synthesis gas and catalyst.

In addition to ammonia synthesis, the process can also be used to fix nitrogen by synthesising nitrogen oxides (NOₓ), hydrocyanic acid (HCN), nitric acid (HNO₃) and urea (CH₄N₂O).

In some embodiments, the gaseous reactants may be selected from the group consisting of hydrogen (H₂), nitrogen (N₂), oxygen (O₂) and methane (CH₄), as well as other gaseous hydrocarbons. Reactants such as peroxyacetyl nitrate (PAN; CH₃C(O)OONO₂), peroxypropionyl nitrate (PPN; C₂H₅C(O)OONO₂), peroxybenzoyl nitrate (PBZN; C₆H₅C(O)OONO₂), peroxyacryloyl nitrate (APAN; CH₂CHC(O)OONO₂), peroxyisobutyryl nitrate (PiBN; (CH₃)₂CHC(O)OONO₂) or peroxymethacryloyl nitrate (MPAN; CH₂C(CH₃)C(O)OONO₂) can also be used, possibly even as the sole reactant.

In some embodiments, the gaseous catalyst may be a gas that is not physically or chemically bound in the reaction products by the chemical reactions of nitrogen fixation. For example, the gaseous catalyst may be a noble gas, preferably argon, helium, neon, xenon and radon.

In some embodiments, noble gases can be added in the following preferred molar proportions:

| | |
|---|---|
| argon | 3-13% |
| helium | 6-25% |
| neon | 10-25% |
| xenon | 1-13% |
| radon | 1-13% |

In some embodiments, the synthesis may be carried out at atmospheric pressure or more, preferably at a pressure of at least 2 bar, more preferably at least 5 bar.

In some embodiments, the synthesis may be carried out at a temperature of at most 100° C., preferably 25° C. or less. The synthesis may also be carried out at a temperature of less than 0° C.

In some embodiments, the process can be carried out with an additional solid-state catalyst. However, the present invention uses gaseous catalysts in electrochemical synthesis processes for nitrogen fixation, so that solid-state catalysts can be dispensed with. Accordingly, it is preferred that no solid-state catalyst is used.

In some embodiments, the plasma may be generated by means of direct-current discharges, high-frequency discharges, laser ionisation, radioactive radiation, pulsed direct-current discharges or combinations thereof.

In the case of high-frequency discharges, the process gas can be excited by alternating electromagnetic fields (for example radio frequency or microwave discharge). Typical frequencies here range from 1 kHz to 100 GHZ. Duty cycles between 0 and 100% can be used for pulsed direct-current discharge. The pulse duration can range here from 1 millisecond to 1 femtosecond. The amplitudes of the alternating electromagnetic fields can range from 100 V to 100 MV.

In some embodiments, the plasma may be in thermal equilibrium, in which the mean electron temperature is equal to the mean ion and neutral particle temperature, preferably it may have at least a slight thermal disequilibrium, in which the mean electron temperature is one order of magnitude higher than the mean ion and neutral particle temperature, more preferably it may have an extreme thermal disequilibrium, in which the mean electron temperature is several orders of magnitude higher than the mean ion and neutral particle temperature.

Another advantage over existing methods the is possibility of completely eliminating the CO₂ emissions in methods. In produced such the conventional Haber-Bosch process, for example, fossil fuels such as gas or coal are directly integrated into the process sequence. In electrochemical methods, on the other hand, the entire synthesis can be carried out using renewable energies.

### BRIEF EXPLANATION OF THE FIGURES

The invention will be explained in greater detail below on the basis of practical examples in conjunction with the drawing(s), in which:

FIG. 1 shows a diagram of a method of nitrogen fixation.

### WAYS OF CARRYING OUT THE INVENTION

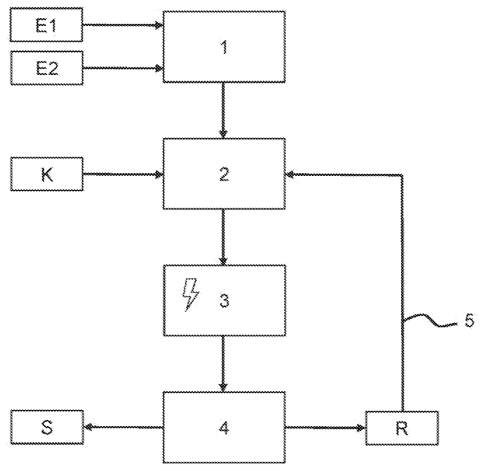

FIG. 1 shows a diagram of a method of nitrogen fixation. In a first step 1, a synthesis gas is provided from several reactants E1, E2. In a second step 2, synthesis gas and a gaseous catalyst K are combined to form a process gas, with defined ratios of reactants and catalyst, and lastly are fed into a plasma reactor 3. The synthesis product S is synthesised in the plasma reactor and is then separated from the remaining process gases R in a step 4. The remaining process gases R, which contain reduced quantities of the reactants, are recycled and enriched with new synthesis gas so that a process gas with defined ratios of reactants and catalyst is provided again.

The mixing ratio in proportions of the reactants is determined as follows:
a.1) determine all atom types of the synthesis product;
a.2) calculate the reciprocal value of the total effective cross section for the ionisation and excitation of atoms by electron impacts (at approximately 5 eV) of the respective atom type;
a.3) multiply the reciprocal total effective cross section values of the atom types by the number of atoms of the respective atom type of the synthesis product (weighted reciprocal total effective cross section of the atom types);
a.4) determine the mixing ratio of the reactants by making the number of atom types of the reactants correspond approximately to the ratio of the multiplied or weighted reciprocal total effective cross section values for the corresponding atom types.

Example 1—Ammonia synthesis (NH₃) from N₂ and H₂

Step a.1: The synthesis product ammonia NH₃ consists of the atom types N and H.

Step a.2: The total effective cross section (wq) [in 10\hat{ }-20 m2] for N and H is wqN=14 and wqH=5, respectively. The reciprocal value (1/wq) is 1/wqN=0.07 and 1/wqH=0.2, respectively. The sum of the reciprocal values (1/wq) for all atoms of the respective atom types (N and H) of the synthesis product are for 1×1/wqN=0.07 and for 3×1/wqH=0.6 (step a.3). This results in an optimum mixing ratio for N₂:H₂ of 1:8.4 or an approximate mixing ratio of 1:9 (step a.4).

| | | | | | |
|---|---|---|---|---|---|
| Step a.1: | NH₃ = | N | H | H | H |
| Step a.2: | wq [10⁻²⁰ m²] | 14 | 5 | 5 | 5 |
| | 1/wq | 0.07 | 0.2 | 0.2 | 0.2 |
| Step a.3: | | N | 3*H | | |
| | | 0.07 | 0.6 | | |
| Step a.4 | 1/wq weighted and standardised | 1 (N) | 8.4 (H) | | |
| | according to atom type | | | | |

The reactants N₂ and H₂ have two N and two H, respectively,
and are mixed correspondingly in the ratio according to
step a.4 (N₂:H₂ = 1:8.4). Rounded mixing ratio of the
reactants is then N₂:H₂ = 1:9

### Example 2—NO

| | | | |
|---|---|---|---|
| Step a.1: | NO₃ = | N | O |
| Step a.2: | wq [10⁻²⁰ m²] | 14 | 0.003 |
| | 1/wq | 0.07 | 333 |
| Step a.3: | | 1* N | 1* O |
| | | 0.07 | 333 |
| Step a.4 | 1/wq weighted and standardised | 1 (N) | 4662 (0) |
| | according to atom type | | |

The reactants N₂ and O₂ have two N and two O, respectively,
and are mixed correspondingly in the ratio according to
step a.4 (N₂:O₂ = 1:4662).

### Example 3—NO₂

| | | | | |
|---|---|---|---|---|
| Step a.1: | NO₂ = | N | O | O |
| Step a.2: | wq [10⁻²⁰ m²] | 14 | 0.003 | 0.003 |
| | 1/wq | 0.07 | 333 | 333 |
| Step a.3: | | N | 2* O | |
| | | 0.07 | 666 | |
| Step a.4 | 1/wq weighted and standardised | 1 (N) | 9333 (O) | |
| | according to atom type | | | |

The reactants N₂ and O₂ have two N and two O, respectively,
and are mixed correspondingly in the ratio according to
step a.4 (N₂:O₂ = 1:9333).

### Example 4—NO₃

| | | | | | |
|---|---|---|---|---|---|
| Step a.1: | NO₃ = | N | O | O | O |
| Step a.2: | wq [10⁻²⁰ m²] | 14 | 0.003 | 0.003 | 0.003 |
| | 1/wq | 0.07 | 333 | 333 | 333 |
| Step a.3: | | N | 3* O | | |
| | | 0.07 | 1000 | | |
| Step a.4 | 1/wq weighted and | 1 (N) | 14000 (O) | | |
| | standardised | | | | |
| | according to atom type | | | | |

The reactants N₂ and O₂ have two N and two O, respectively,
and are mixed correspondingly in the ratio according to
step a.4 (N₂:O₂ = 1:14000).

### Example 5—HNO₃

| | | | | | | |
|---|---|---|---|---|---|---|
| Step a.1: | HNO₃ = | N | H | O | O | O |
| Step a.2: | wq [10⁻²⁰ m²] | 14 | 5 | 0.003 | 0.003 | 0.003 |
| | 1/wq | 0.07 | 0.2 | 333 | 333 | 333 |
| Step a.3: | | N | H | 3* O | | |
| | | 0.07 | 0.2 | 1000 | | |
| Step a.4 | 1/wq weighted and standardised according to atom type | 1 (N) | 2.8 (H) | 14000 (O) | | |

The reactants N₂; H₂ and O₂ have two N, two H and two O, respectively, and are mixed
correspondingly in the ratio according to step a.4 (N₂:H₂:O₂ = 1:2.8:14000).

### LIST OF REFERENCE SIGNS

1 mixing of the reactants to form a synthesis gas
2 provision of the process gas (synthesis gas and gaseous catalyst)
3 synthesis in the plasma reactor
4 separation of the synthesis product from the residual process gas
5 recycling of the residual process gas
E1, E2 reactant
K gaseous catalyst
S synthesis product
R residual process gas

1-12. (canceled)

13. A method of nitrogen fixation in a plasma reactor, wherein the method comprises:
a) providing a synthesis gas formed of several gaseous reactants for the synthesis of a synthesis product, wherein the mixing ratio in molar proportions of the several gaseous reactants is determined as follows:
determining all atom types in the synthesis product;
calculating the reciprocal of the total effective cross section for the ionization and excitation of atoms by electron impacts on the respective atom type;
multiplying the reciprocal total effective cross section values of the atom types by the number of atoms of the respective atom type in the synthesis product;
determining the mixing ratio of the reactants, in that the number of atoms of the atom types in the reactants corresponds approximately to the ratio of the multiplied reciprocal total effective cross section values for the corresponding atom types;
b) providing a process gas by admixing a gaseous catalyst with the synthesis gas, wherein the molar proportion of the catalyst in the process gas is not more than 33%;
c) introducing the process gas into a plasma reactor for the synthesis of the synthesis product from the reactants;
d) separating off the synthesis product;
e) recycling the excess or residual reactants and the gaseous catalyst, with admixture of new reactants, in order to obtain the process gas with the mixing ratios according to steps a) and b);
f) repeating steps c) to f).

14. The method according to claim 13, wherein the gaseous reactants are selected from the group consisting of hydrogen (H₂), nitrogen (N₂), oxygen (O₂), and methane (CH₄).

15. The method according to claim 14, wherein the gaseous reactants are selected from the group consisting of peroxyacetyl nitrate (PAN; CH₃C(O)OONO₂), peroxypropionyl nitrate (PPN; C₂H₅C(O)OONO₂), peroxybenzoyl nitrate (PBZN; C₆H₅C(O)OONO₂), peroxyacrylol nitrate (APAN; CH₂CHC(O)OONO₂), peroxyisobutyryl nitrate (PiBN; (CH₃)₂CHC(O)OONO₂), and peroxymethacryloyl nitrate (MPAN; CH₂C(CH₃)C(O)OONO₂).

16. The method according to claim 13, wherein the gaseous catalyst is a gas that is not bound physically or chemically in the reaction products by the chemical reactions of the nitrogen fixation.

17. The method according to claim 13, wherein the gaseous catalyst is a noble gas.

18. The method according to claim 17, wherein the gaseous catalyst is argon, helium, neon, xenon, or radon.

19. The method according to claim 18, wherein the molar proportion of the noble gases argon, helium, neon, xenon and radon has the following values:

| | |
|---|---|
| argon | 3-13% |
| helium | 6-25% |
| neon | 10-25% |
| xenon | 1-13% |
| radon | 1-13%. |

20. The method according to claim 13, wherein the synthesis is performed at atmospheric pressure or more, preferably at a pressure of at least 2 bar, more preferably at least 5 bar.

21. The method according to claim 13, wherein the synthesis is performed at a temperature of at most 100° C.

22. The method according to claim 21, wherein the synthesis is performed at a temperature of 25° C. or less.

23. The method according to claim 13, wherein the synthesis is performed at a temperature of less than 0° C.

24. The method according to claim 13, wherein no solid-state catalyst is used.

25. The method according to claim 13, wherein the plasma is produced by means of direct-current discharges, high-frequency discharges, laser ionisation, radioactive radiation, pulsed direct-current discharges or combinations thereof.

26. The method according to claim 13, wherein the plasma is in thermal equilibrium in which the mean electron temperature is equal to the mean ion and neutral particle temperature.

27. The method according to claim 26, wherein the mean ion and neutral particle temperature has at least a slight thermal disequilibrium, in which the mean electron temperature is one order of magnitude higher than the mean ion and neutral particle temperature.
